(19) United States
(12) Patent Application Publication
(10) Pub. No.: US 2019/0308565 A1
(43) Pub. Date: Oct. 10, 2019

(54) DEPLOYABLE SENSOR ASSEMBLY

(71) Applicant: Huf North America Automotive Parts Manufacturing Corp., Milwaukee, WI (US)

(72) Inventors: Lynn D. Da Deppo, Bloomfield Hills, MI (US); Jeffery T. Root, Howell, MI (US); Doug Carson, West Bloomfield, MI (US); David Newkirk, West Bloomfield, MI (US); Ehab Kamal, Novi, MI (US)

(21) Appl. No.: 16/461,814

(22) PCT Filed: Nov. 11, 2017
(86) PCT No.: PCT/US2017/062182

§ 371 Date: May 17, 2019

Related U.S. Application Data
(60) Provisional application No. 62/423,984, filed on Nov. 18, 2016.

(51) Int. Cl. B60R 11/04

(52) U.S. Cl. CPC B60R 11/04; B60R 2011/004

(57) ABSTRACT

An assembly including a housing, a pivot bracket, a sensor, a primary actuation mechanism, and a secondary actuation mechanism is disclosed. The pivot bracket is supported for rotation about a first axis relative to the housing between a first position and a second position. The sensor is supported for rotation with the pivot bracket. The primary actuation mechanism is supported for rotation about a second axis relative to the pivot bracket. The primary actuation mechanism is operable to apply a first torque on the pivot bracket about the first axis. The secondary actuation mechanism is operable to: (i) apply a second torque on the pivot bracket about the first axis when the pivot bracket is in the first position; and (ii) apply a third torque on the pivot bracket about the first axis when the pivot bracket is in the second position, the second torque being opposite the third torque.

### CROSS REFERENCE TO RELATED APPLICATION

This application claims priority to U.S. Provisional Application Ser. No. 62/423,984, filed Nov. 18, 2016, the contents of which are incorporated by reference in their entirety.

### FIELD

The present disclosure relates generally to a sensor assembly for a vehicle and more particularly to a deployable sensor assembly for a vehicle.

### BACKGROUND

This section provides background information related to the present disclosure and is not necessarily prior art.

Many motor vehicles now come equipped with some variation of a camera or sensor system to provide real-time monitoring or viewing of an area near the motor vehicle. For example, cameras, sensors, or both are often positioned on the front of the vehicle or on the rear of the motor vehicle. The cameras and sensors can detect the areas surrounding the vehicle that may or may not be otherwise viewable with conventional mirrors. Such cameras and sensors can be used to assist the vehicle operator in parking or maneuvering the vehicle during normal operation, for example.

To provide a consistent field of view, many camera and sensor systems do not include a cover and are fixedly directed at the space they are intended to monitor. Uncovered cameras and sensors are prone to damage from environmental conditions and exposure, including damage from dirt and stone chipping, and also from human intervention, including theft. To better protect the camera, sensor, or other device, some vehicles utilize a deployable system in which an electric motor, for example, drives the camera between an open or “deployed” position and a closed or “stowed” position.

While conventional deployable systems position a camera or sensor between a deployed position and a stowed position, such systems are not usable in conjunction with a movable closure panel such as a tailgate or liftgate in more than one deployed position. For example, while conventional deployable systems position a camera or sensor in a deployed position for use when the closure panel is in a closed position, use of the camera or sensor to monitor areas surrounding the vehicle when the closure panel is in an open position (i.e., a tailgate of a truck is lowered or a liftgate of a sport utility vehicle (SUV) is in a raised position) is not possible due to the position of the tailgate or liftgate relative to the vehicle.

For example, when the camera or sensor is in the deployed position, the camera or sensor is typically positioned at an angle to view an area behind the vehicle. When the liftgate is moved into the raised position or the tailgate is moved into the lowered position, the camera or sensor remains in the same deployed position relative to the liftgate or tailgate. As such, the camera or sensor views an area above the vehicle in the case of a liftgate or the ground under the tailgate due to the change in position of the liftgate or tailgate relative to the vehicle. Maintaining the relative position of the camera or sensor and the liftgate or tailgate renders the camera or sensor ineffective in viewing an area behind the vehicle should the vehicle be operated with the liftgate in the raised position or the tailgate in the lowered position.

### SUMMARY

This section provides a general summary of the disclosure, and is not a comprehensive disclosure of its full scope or all of its features.

One aspect of the disclosure provides an assembly including a housing, a pivot bracket, a sensor, a primary actuation mechanism, and a secondary actuation mechanism. The pivot bracket is supported for rotation about a first axis relative to the housing between a first position and a second position. The sensor is supported for rotation with the pivot bracket. The primary actuation mechanism is supported for rotation about a second axis relative to the pivot bracket. The primary actuation mechanism is operable to apply a first torque on the pivot bracket about the first axis. The secondary actuation mechanism is operable to: (i) apply a second torque on the pivot bracket about the first axis when the pivot bracket is in the first position; and (ii) apply a third torque on the pivot bracket about the first axis when the pivot bracket is in the second position, the second torque being opposite the third torque.

Implementations of the disclosure may include one or more of the following optional features. In some implementations, the primary actuation mechanism is rotatably coupled to the pivot bracket. Additionally or alternatively, the primary actuation mechanism may be rotatably coupled to the secondary actuation mechanism. The secondary actuation mechanism may include a torsion spring having a first end coupled to the pivot bracket, a second end coupled to the housing, and a coil disposed about a portion of the primary actuation mechanism. The secondary actuation mechanism may include a spring coupled to the pivot bracket and having a key portion, the housing defining a cam surface configured to slidably engage the key portion.

The cam surface may define a first detent configured to receive the key portion in the first position, and a second detent configured to receive the key portion in the second position. The secondary actuation mechanism may also include a boot pivotally coupled to the pivot bracket, a plunger pivotally coupled to the housing, and a biasing member operable to biasingly engage the boot and the plunger. The biasing member may include a compression spring.

In some examples, the assembly includes a vehicle body and a tailgate supported for rotation by the vehicle body between a closed position and an open position. The housing may be supported by the tailgate, wherein the pivot bracket is in the first position when the tailgate is in the closed position, and the pivot bracket is in the second position when the tailgate is in the open position.

Another aspect of the disclosure provides a sensor assembly for installation into a component of a vehicle and movable between a plurality of positions relative to the vehicle. The assembly includes a component biased based on gravitational orientation, a positional state of the component from one of two component positions, and a means of maintaining gravity bias in the preferred of the two positions.

This aspect may include one or more of the following optional features. In some examples, the sensor assembly includes a primary actuation mechanism that actuates the positioning of the component between a first position and a second position based on the positioning of the vehicle moveable member. The means of maintaining gravity bias may include a biasing element operable to bias the primary actuation mechanism to a first or a second position once the primary actuation mechanism rotates beyond a predetermined position. The biasing element may also include one of a torsion spring, an extension spring, a compression spring, and a leaf spring.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1A is a perspective view of a vehicle having a tailgate and a deployable sensor system in accordance with the principles of the present disclosure, the tailgate shown in a latched state;

FIG. 1B is a perspective view of the vehicle of FIG. 1A, the tailgate shown in an unlatched state;

FIG. 2 is an exploded view of a deployable sensor assembly for use with the vehicle of FIGS. 1A and 1B in accordance with the principles of the present disclosure;

FIG. 3A is a cross-sectional view of the deployable sensor assembly of FIG. 2 in a first position according to the principles of the present disclosure;

FIG. 3B is a cross-sectional view of the deployable sensor assembly of FIG. 2 in a second position according to the principles of the present disclosure;

FIG. 4 is an exploded view of a deployable sensor assembly for use with the vehicle of FIGS. 1A and 1B in accordance with the principles of the present disclosure;

FIG. 5A is a side view of the deployable sensor assembly of FIG. 4 in a first position according to the principles of the present disclosure;

FIG. 5B is a side view of the deployable sensor assembly of FIG. 4 in a second position according to the principles of the present disclosure;

FIG. 6 is an exploded view of a deployable sensor assembly for use with the vehicle of FIGS. 1A and 1B in accordance with the principles of the present disclosure;

FIG. 7A is a side view of the deployable sensor assembly of FIG. 6 in a first position according to the principles of the present disclosure; and

FIG. 7B is a side view of the deployable sensor assembly of FIG. 6 in a second position according to the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

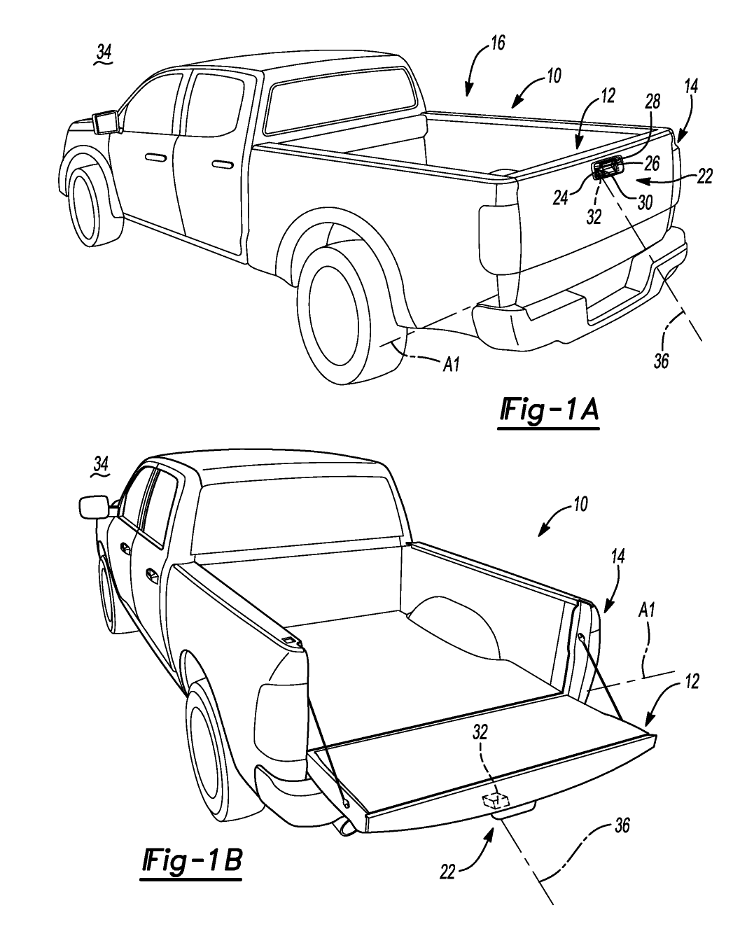

With reference to FIGS. 1A and 1B, a vehicle 10 is provided. The vehicle 10 may be any known variety of vehicle, such as a car, a truck, or a van, for example. The vehicle 10 may include a closure 12 and a body assembly 14. The closure 12 may be movably coupled to the body assembly 14 to allow a user to access, and/or to prevent the user from accessing, a portion of the vehicle 10. In some configurations, the closure 12 may include a tailgate assembly movably coupled to, and/or supported by, the body assembly 14. In this regard, the closure 12 may be referred to herein as the tailgate assembly 12. Accordingly, the tailgate assembly 12 may be coupled to the body assembly 14 for rotation about an axis A1 to allow the user to access, and/or restrict the user from accessing, a bed portion 16 of the vehicle 10. For example, the tailgate assembly 12 may rotate about the axis A1 relative to the body assembly 14 between a closed position (FIG. 1A) and an open position (FIG. 1B).

The tailgate assembly 12 may include a handle assembly 22 for permitting the user to rotate the tailgate assembly 12 from the closed position to the open position. The handle assembly 22 may include a housing 24, a button paddle 26, a handle 28, a shield 30, and a sensor assembly 32. The button paddle 26 may be actuatably (e.g., translatably) coupled to the housing 24 or the handle 28. In this regard, upon actuation (e.g., by a user), the button paddle 26 may cause a latch system (not shown) to move from a latched position to an unlatched position, thus allowing the user to move (e.g., by engaging the handle 28) the tailgate assembly 12 from the closed position to the open position. The shield 30 may be coupled to the housing 24 to separate and protect the sensor assembly 32 from an area 34 surrounding the vehicle 10, while also allowing the sensor assembly 32 to sense (e.g., view) the area 22 surrounding the vehicle 10.

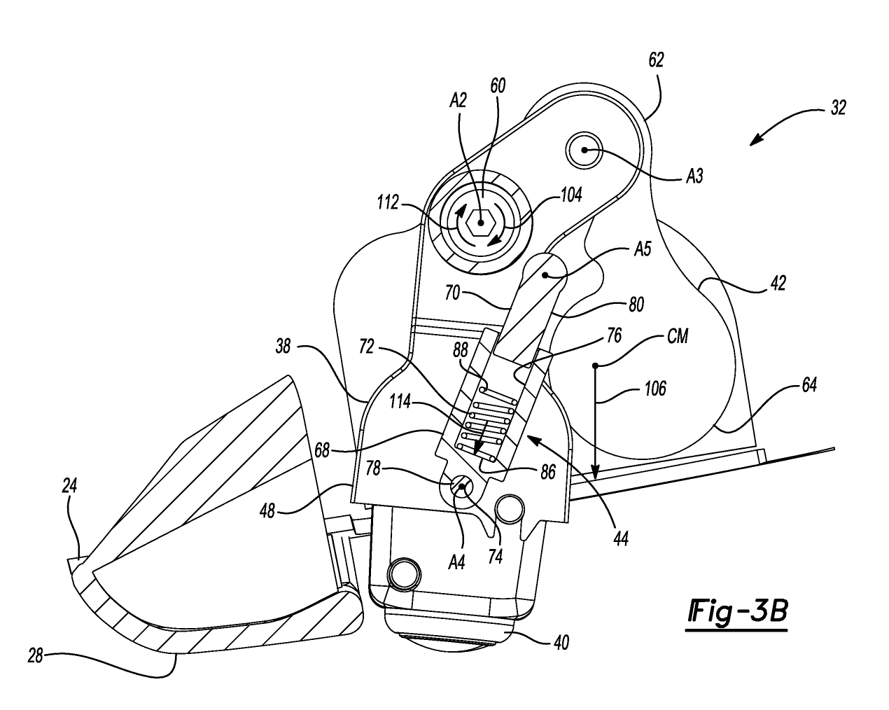

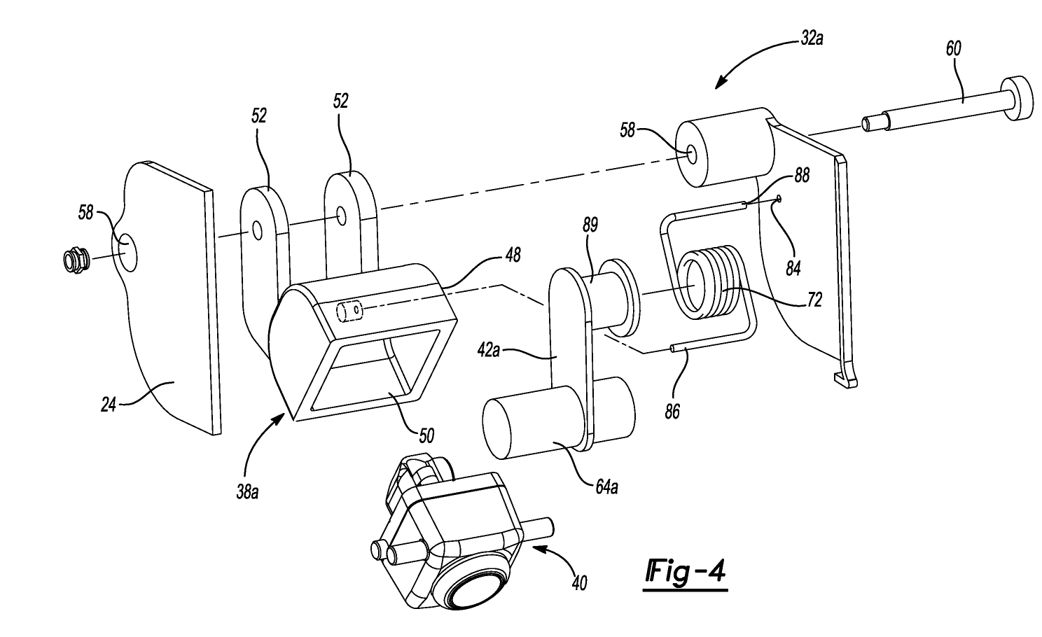

As will be explained in more detail below, the position of the sensor assembly 32 may be controllable relative to the vehicle 10 (e.g., relative to the tailgate assembly 12) to maintain a sensing line 36 relative to the vehicle 10. In particular, the sensor assembly 32 may be movable (e.g., rotatable, pivotable, translatable, etc.) between a first position (FIG. 3A) and a second position (FIG. 3B), such that the sensing line 36 defines a constant angular orientation relative to the vehicle 10 whether the tailgate assembly 12 is in the closed position or the open position. In this regard, in the first position (FIG. 3A), the sensor assembly 32 may maintain the orientation of the sensing line 36 illustrated in FIG. 1A, and in the second position (FIG. 3B), the sensor assembly 32 may maintain the orientation of the sensing line 36 illustrated in FIG. 1B.

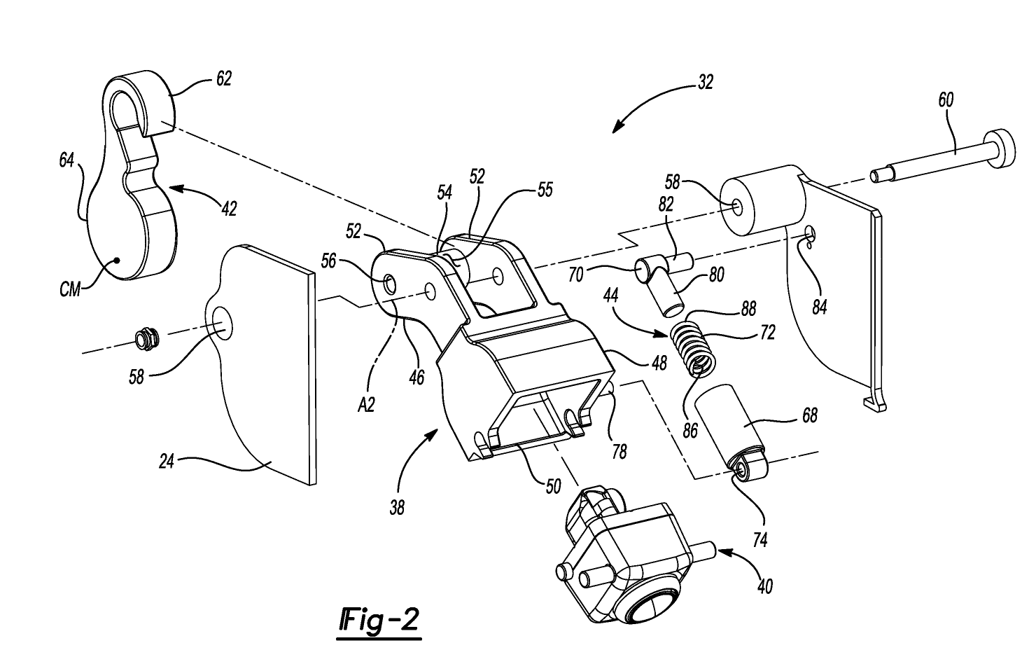

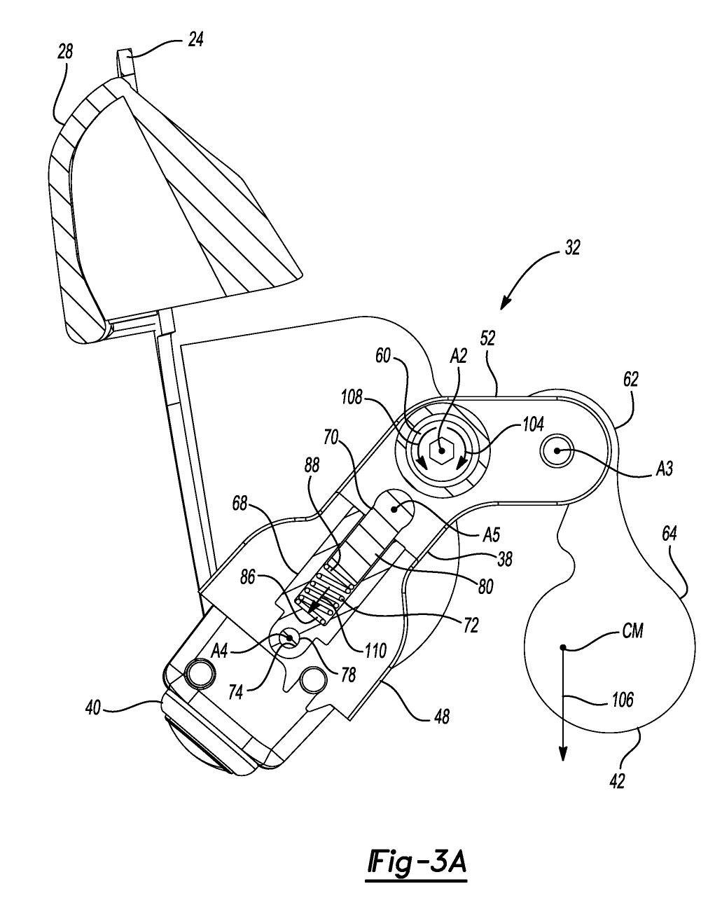

With reference to FIGS. 2-3B, the sensor assembly 32 is provided and may include a pivot bracket 38, a sensor 40, a primary actuation mechanism 42, and a secondary actuation mechanism 44. The pivot bracket 38 may include a support portion 46 and a sensor-receiving portion 48 defining an opening 50. The support portion 46 may include a pair of arms 52 and a beam 54, having a generally cylindrical outer surface 55, extending therebetween. As illustrated in FIGS. 3A and 3B, the pivot bracket 38 may be pivotally attached to a portion of the vehicle 10 for rotation about an axis A2. In this regard, the arms 52 may each include a first rotation feature 56 (e.g., a hub, an axle, etc.) and the housing 24 may include one or more second rotation features 58 (e.g., a hub, an axle, etc.) coupled to the first rotation features 56 for rotation about the axis A2. In some implementations, the first and second rotation features 56, 58 each define an aperture, and the sensor assembly 32 includes an axle 60 disposed within the first and second rotation features 56, 58, such that the pivot bracket 38 rotates relative to the vehicle 10 about the axle 60 and the axis A2. The axis A2 may extend in a direction substantially parallel to, and may be offset from, the axis A1.

The sensor 40 is disposed within the pivot bracket 38 for rotation therewith. For example, in some implementations, the sensor 40 is disposed within the opening 50 in an assembled configuration. While element 40 is referred to herein as a “sensor,” element 40 could be any type of sensor such as, for example, a camera or a motion sensor.

The primary actuation mechanism 42 defines a center of mass CM and may include a coupling portion 62 and an actuating portion 64. The coupling portion 62 may define a hook-shape that, in the assembled configuration, is coupled to the pivot bracket 38 for rotation about an axis A3. For example, the hook-shape of the coupling portion 62 may slidably engage the outer surface 55 of the beam 54 as the primary actuation mechanism 42 rotates about the axis A3. The axis A3 may extend in a direction substantially parallel to, and may be offset from, the axes A1 or A2.

The secondary actuation mechanism 44 may include a boot 68, a plunger 70, and a biasing member 72. The boot 68 may include a third rotation feature 74 (e.g., a hub, an axle, etc.) and a chamber 76. The third rotation feature 74 may be rotatably coupled to a fourth rotation feature 78 (e.g., a hub, an axle, etc.) for rotation about an axis A4. The fourth rotation feature 78 may be disposed on or defined by one of the pivot bracket 38 and the sensor 40. As illustrated, in some implementations, the fourth rotation feature 78 includes a pin or other suitable projection extending from the sensor-receiving portion 48 of the pivot bracket 38, and the third rotation feature 74 includes an aperture defined by the boot 68. In the assembled configuration, the fourth rotation feature 78 may be disposed within the third rotation feature 74 for rotation about the axis A4. The axis A4 may extend in a direction substantially parallel to, and may be offset from, the axes A1, A2, and/or A3.

The plunger 70 may include a stem portion 80 and a fifth rotation feature 82 (e.g., a hub, an axle, etc.). In an assembled configuration, the stem portion 80 may be translatably disposed within the chamber 76 of the boot 68, and the fifth rotation feature 82 may be rotatably coupled to a sixth rotation feature 84 (e.g., a hub, an axle, etc.) for rotation about an axis A5. As illustrated in FIG. 2, the sixth rotation feature 84 may be disposed on or defined by a portion of the vehicle 10. In some implementations, the fifth rotation feature 82 includes an axle extending transversely (e.g., perpendicularly) from the stem portion 80, and the sixth rotation feature 84 includes an aperture defined by the housing 24. In the assembled configuration, the fifth rotation feature 82 may be disposed within the sixth rotation feature 84 for rotation about the axis A5. The axis A5 may extend in a direction substantially parallel to, and may be offset from, the axes A1, A2, A3, and/or A4.

The biasing member 72 may include a coil spring (e.g., a compression spring) extending from a first end 86 to a second end 88. In the assembled configuration, the biasing member 72 may be at least partially disposed within the chamber 76 of the boot 68. In this regard, the first end 86 may be coupled to the boot 68, and the second end 88 may be coupled to the plunger 70.

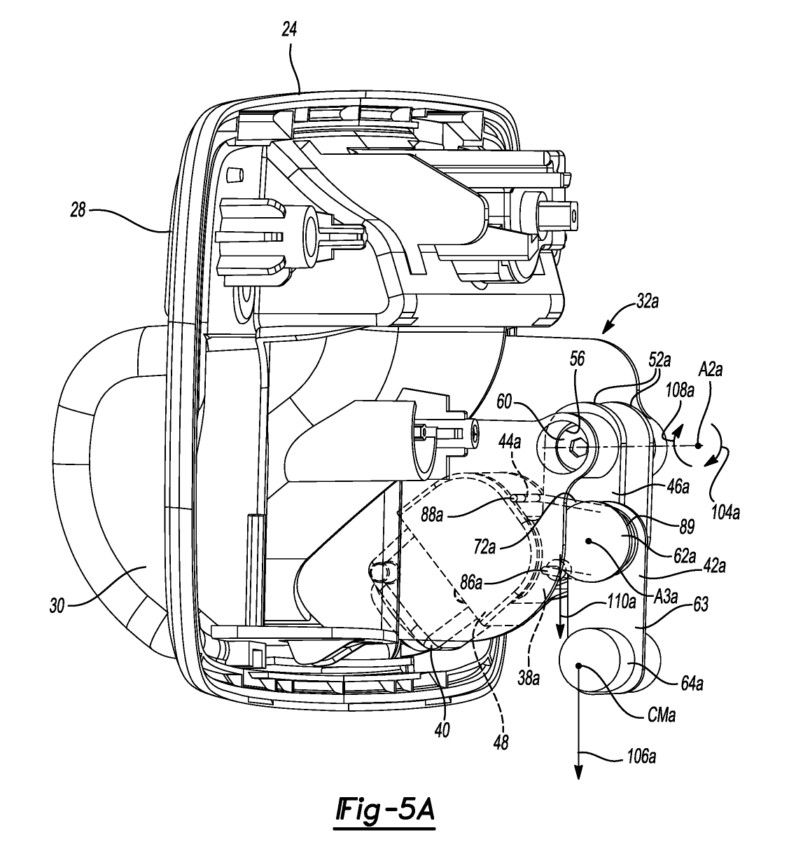

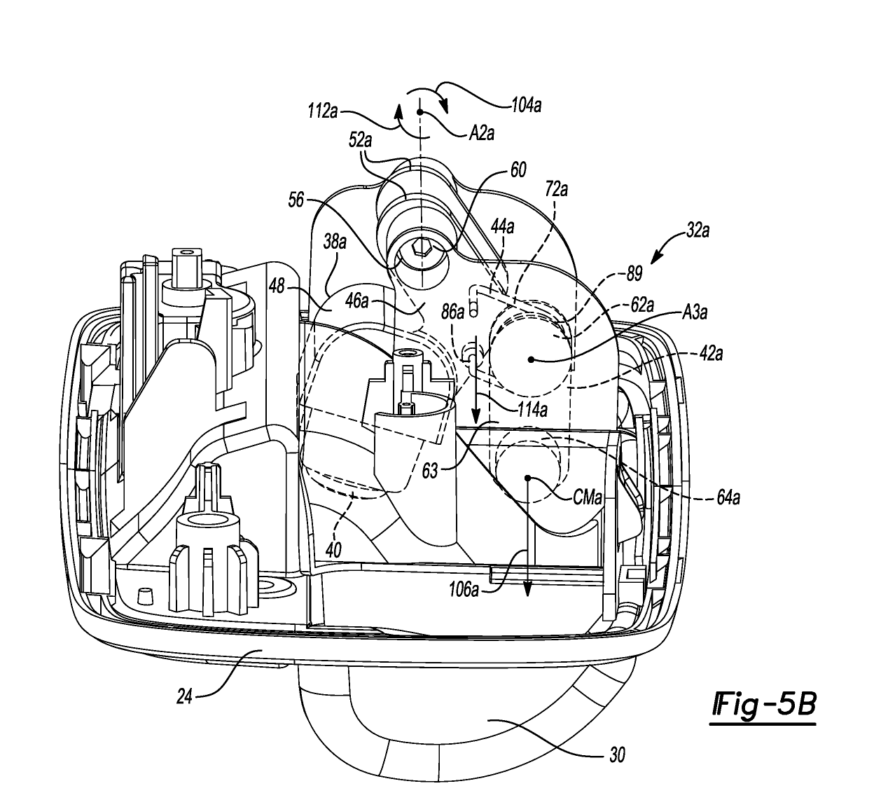

With reference to FIGS. 4-5B, another sensor assembly 32a is shown. The structure and function of the sensor assembly 32a may be substantially similar to that of the sensor assembly 32, apart from any exceptions described below and/or shown in the Figures. Accordingly, the structure and/or function of similar features will not be described again in detail. In addition, like reference numerals are used hereinafter and in the drawings to identify like features, while like reference numerals containing letter extensions (i.e., “a”) are used to identify those features that have been modified.

The sensor assembly 32a may include a pivot bracket 38a, the sensor 40, a primary actuation mechanism 42a, and a secondary actuation mechanism 44a. The pivot bracket 38 may include a support portion 46a and the sensor-receiving portion 48. The support portion 46a may include a pair of arms 52a. The pivot bracket 38a may be pivotally attached to a portion of the vehicle 10 for rotation about an axis A2a. In this regard, the arms 52 may each include the first rotation feature 56 (e.g., a hub, an axle, etc.) and the housing 24 may include one or more of the second rotation features (not shown) (e.g., a hub, an axle, etc.) coupled to the first rotation feature 56 for rotation about the axis A2a. The axle 60 may be disposed within the first and second rotation features 56, 58, such that the pivot bracket 38a rotates relative to the vehicle 10 about the axle 60 and the axis A2a. The axis A2a may extend in a direction substantially parallel to, and offset from, the axis A1.

The primary actuation mechanism 42a defines a center of mass CMa and may include a coupling portion 62a, an arm 63, and an actuating portion 64a. The coupling portion 62a may include a generally cylindrical outer surface (not shown) surrounding an axis A3a. The axis A3a may extend in a direction substantially parallel to, and offset from, the axes A1 and/or A2a. The arm 63 may extend from and between the coupling portion 62a and the actuating portion 64a in a direction transverse to the axis A3a.

The secondary actuation mechanism 44a may include a biasing member 72a (e.g., a helical torsion spring) having a first end 86a, a second end 88a, and a coil portion 89 extending from and between the first and second ends 86a, 88a. In the assembled configuration, the secondary actuation mechanism 44a may be coupled to the primary actuation mechanism 44a for rotation about the axis A3a. For example, the first end 86a of the secondary actuation mechanism 44a may be coupled to the pivot bracket 38a, the second end 88a of the secondary actuation mechanism 44a may be coupled to a portion of the vehicle 10, and the coil portion 89 of the secondary actuation mechanism 44a may be disposed about the cylindrical outer surface of the coupling portion 62a of the primary actuation mechanism 42a.

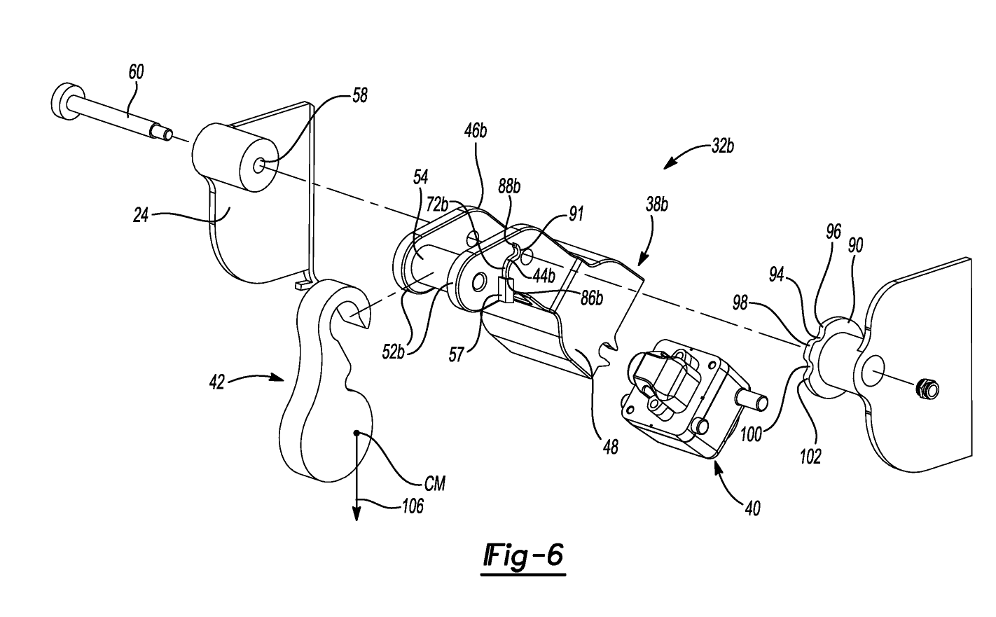

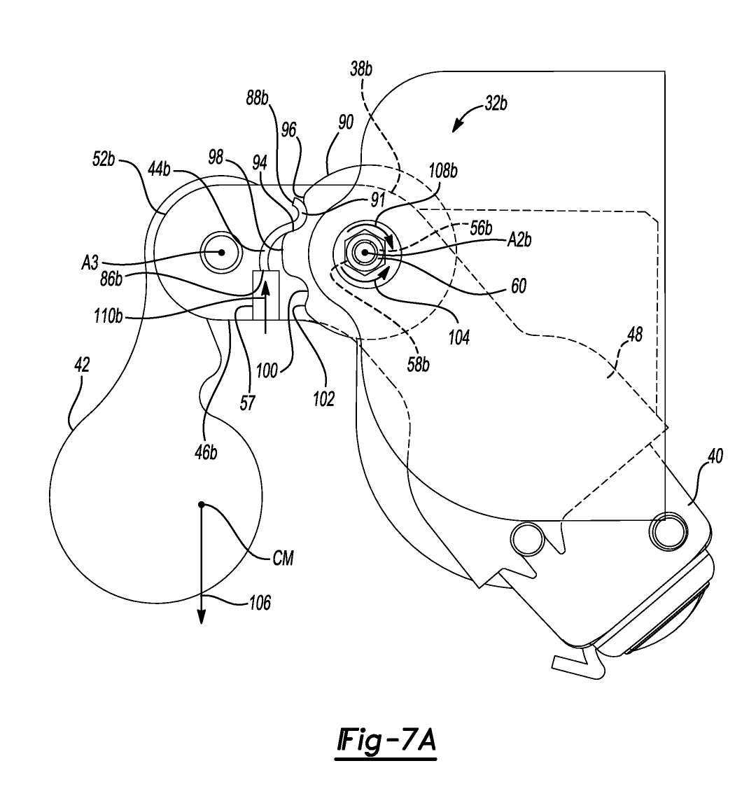

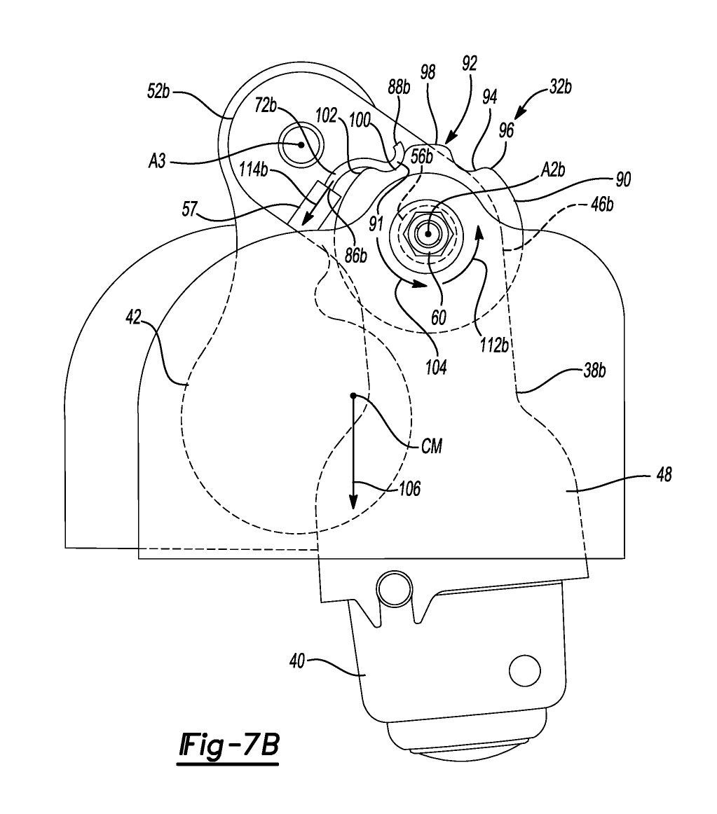

With reference to FIGS. 6-7B, another sensor assembly 32b is shown. The structure and function of the sensor assembly 32b may be substantially similar to that of the sensor assembly 32, apart from any exceptions described below and/or shown in the Figures. Accordingly, the structure and/or function of similar features will not be described again in detail. In addition, like reference numerals are used hereinafter and in the drawings to identify like features, while like reference numerals containing letter extensions (i.e., “b”) are used to identify those features that have been modified.

The sensor assembly 32b may include may include a pivot bracket 38b, the sensor 40, the primary actuation mechanism 42, and a secondary actuation mechanism 44b. The pivot bracket 38b may include a support portion 46b and the sensor-receiving portion 48. The support portion 46b may include a pair of arms 52b and the beam (not shown). As illustrated in FIGS. 7A and 7B, the pivot bracket 38b may be pivotally attached to a portion of the vehicle 10 for rotation about an axis A2b. In this regard, the arms 52b may include a first rotation feature 56b (e.g., a hub, an axle, etc.) and a tab 57 projecting axially (relative to the axis A2b) from one of the arms 52b. The housing 24b may further include one or more of the second rotation features 58 coupled to the first rotation features 56b for rotation about the axis A2b. In some implementations, the first and second rotation features 56b, 58 each define an aperture, and the sensor assembly 32b includes the axle 60 disposed within the first and second rotation features 56b, 58, such that the pivot bracket 38b rotates relative to the vehicle 10 about the axle 60 and the axis A2b. The axis A2b may extend in a direction substantially parallel to, and may be offset from, the axis A1.

The secondary actuation mechanism 44b may include a biasing member 72b. The biasing member 72b may extend in an arcuate (e.g., serpentine) shape from a first end 86b to a second end 88b. In this regard, the biasing member 72b may include or define a key portion 91 disposed between the first and second ends 86b, 88b. In the assembled configuration, the biasing member 72b may be coupled to, and rotatable with, the pivot bracket 38b. In this regard, the first end 86b of the biasing member 72b may be coupled to the tab 57.

The housing 24 may further include a cam surface 90 defining a sinusoidal pattern 92 extending about the axis A2b. The sinusoidal pattern 92 may include a first recess or detent 94 disposed between a first peak 96 and a second peak 98, and a second recess or detent 100 disposed between the second peak 98 and a third peak 102. In some implementations, the first, second, and third peaks 96, 98, 102 may collectively define an arcuate (e.g., circular) shape extending about the axis A2b. As will be explained in more detail below, the key portion 91 of the biasing member 72b may be slidably received by the cam surface 90, such that the key portion 91 moves from and between the first and second detents 94, 100 when the tailgate assembly 12 moves from the first position to the second position.

With particular reference to FIGS. 3A-3B, 5A-5B, and 7A-7B, operation of the sensor assemblies 32, 32a, 32b will be described in detail. The sensor assemblies 32, 32a, 32b may be deployed based on input from a user of the vehicle 12. Namely, when a user rotates the tailgate assembly 12 from the first position (FIG. 1A) to the second position (FIG. 1B), the primary actuation mechanism 42, 42a and the secondary actuation mechanism 44, 44a, 44b may cause the pivot brackets 38, 38a, 38b, and, thus, the sensor 40, to rotate about the axis A2, A2a, A2b from a first position (FIGS. 3A, 5A, 7A) to a second position (FIGS. 3B, 5B, 7B), in order to maintain a constant orientation of the sensing line 36 relative to the vehicle 10.

When the tailgate assembly 12 and the sensor assembly 32, 32a, 32b are in their respective first positions (FIG. 1A and FIGS. 3A, 5A, 7A), the primary actuation mechanism 42, 42a may apply a torque 104, 104a respectively, on the pivot bracket 38, 38a, 38b about the axis A2, A2a, A2b. Namely, the weight 106, 106a of the primary actuation mechanism 42, 42a may produce the torque 104, 104a, respectively, about the axis A2, A2a, A2b. As illustrated in FIGS. 3A, 5A, and 7A, the torque 104, 104a may urge the pivot bracket 38, 38a, 38b to rotate from the first position (FIGS. 3A, 5A, 7A) to the second position (FIGS. 3B, 5B, 7B) about the axis A2, A2a, A2b.

When the tailgate assembly 12 and the sensor assembly 32, 32a, 32b are in their respective first positions, the secondary actuation mechanism 44, 44a, 44b may apply a torque 108, 108a, 108b, respectively, on the pivot bracket 38, 38a, 38b about the axis A2, A2a, A2b. Namely, (i) the biasing member 72 (FIG. 3A) may produce a force 110 on the pivot bracket 38, (ii) the biasing member 72a (FIG. 5A) may produce a force 110a on the pivot bracket 38a, and (iii) the biasing member 72b (FIG. 7A) may produce a force 110b on the pivot bracket 38b. The force 110, 110a, 110b may produce the torque 108, 108a, 108b about the axis A2, A2a, A2b. As illustrated in FIGS. 3A, 5A, and 7A, the torque 108, 108a, 108b may urge the pivot bracket 38, 38a, 38b to rotate toward the first position (FIGS. 3A, 5A, 7A) relative to the second position (FIGS. 3B, 5B, 7B) about the axis A2, A2a, A2b. In this regard, relative to the views shown in FIGS. 3A, 5A, 7A, the primary actuation mechanism 42, 42a may urge the pivot bracket 38, 38a, 38b to rotate in a clockwise direction, and the secondary actuation mechanism 44, 44a, 44b may urge the pivot bracket 38, 38a, 38b to rotate in a counterclockwise direction.

When a user rotates the tailgate assembly 12 about the axis A1 from the first position (FIG. 1A) relative to the vehicle body 14 to the second position (FIG. 1B) relative to the vehicle body, the primary actuation mechanism 42, 42a may rotate about the axis A3, A3a, A3b relative to the pivot bracket 38, 38a, 38b. Rotation of the primary actuation mechanism 42, 42a about the axis A3, A3a, A3b causes the pivot bracket 38, 38a, 38b to rotate about the axis A2, A2a, A2b. For example, as the primary actuation mechanism 42, 42a rotates about the axis A3, A3a, A3b in a clockwise direction relative to the views in FIGS. 3A, 5A, and 7A, the torque 104, 104a produced by the weight 106, 106a may cause the pivot bracket 38, 38a, 38b to rotate about the axis A2, A2a, A2b in the clockwise direction. In some implementations, the torque 104, 104a may cause the pivot bracket 38, 38a, 38b to rotate from the first position 45 degrees about the axis A2, A2a, A2b when the tailgate assembly 12 is rotated from the first position 45 degrees (e.g., by the user) about the axis A1.

As the user continues to rotate the tailgate assembly 12 about the axis A1 toward the second position (FIG. 1B) and past the 45 degree position, the secondary actuation mechanism 44, 44a, 44b may cause the pivot bracket 38, 38a, 38b to further rotate about the axis A2, A2a, A2b. For example, as the tailgate assembly 12 rotates about the axis A1 by an angle greater than 45 degrees, thus causing the pivot bracket 38, 38a, 38b to rotate from the first position by an angle greater than 45 degrees, as described above, the secondary actuation mechanism 44, 44a, 44b may apply a torque 112, 112a, 112b, respectively, on the pivot bracket 38, 38a, 38b about the axis A2, A2a, A2b. Namely, (i) the biasing member 72 (FIG. 3B) may produce a force 114 on the pivot bracket 38, (ii) the biasing member 72a (FIG. 5A) may produce a force 114a on the pivot bracket 38a, and (iii) the biasing member 72b (FIG. 7A) may produce a force 114b on the pivot bracket 38b. With reference to FIGS. 3A-7B, as the pivot bracket 38, 38a, 38b rotates about the axis A2, A2a, A2b from an orientation less than a predetermined angle (e.g., 45 degrees) to an orientation greater than the predetermined angle, the direction (e.g., counterclockwise) of the torque 108, 108a, 108b may reverse to the direction (e.g., clockwise) of the torque 112, 112a, 112b, such that the torque 112, 112a, 112b causes the pivot bracket 38, 38a, 38b to rotate about the axis A2, A2a, A2b in the clockwise direction and into the second position.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. An assembly comprising:
a housing;
a pivot bracket supported for rotation about a first axis relative to the housing between a first position and a second position;
a sensor supported for rotation with the pivot bracket;
a primary actuation mechanism supported for rotation about a second axis relative to the pivot bracket, the primary actuation mechanism operable to apply a first torque on the pivot bracket about the first axis; and
a secondary actuation mechanism operable to (i) apply a second torque on the pivot bracket about the first axis when the pivot bracket is in the first position and (ii) apply a third torque on the pivot bracket about the first axis when the pivot bracket is in the second position, the second torque being opposite the third torque.

2. The assembly of claim 1, wherein the primary actuation mechanism is rotatably coupled to the pivot bracket.

3. The assembly of claim 1, wherein the primary actuation mechanism is rotatably coupled to the secondary actuation mechanism.

4. The assembly of claim 3, wherein the secondary actuation mechanism includes a torsion spring having a first end coupled to the pivot bracket, a second end coupled to the housing, and a coil disposed about a portion of the primary actuation mechanism.

5. The assembly of claim 1, wherein the secondary actuation mechanism includes a spring coupled to the pivot bracket and having a key portion, the housing defining a cam surface configured to slidably engage the key portion.

6. The assembly of claim 5, wherein the cam surface defines a first detent configured to receive the key portion in the first position, and a second detent configured to receive the key portion in the second position.

7. The assembly of claim 1, wherein the secondary actuation mechanism includes a boot pivotally coupled to the pivot bracket, a plunger pivotally coupled to the housing, and a biasing member operable to biasingly engage the boot and the plunger.

8. The assembly of claim 7, wherein the biasing member includes a compression spring.

9. The assembly of claim 1, further comprising a vehicle body and a tailgate supported for rotation by the vehicle body between a closed position and an open position, the housing supported by the tailgate, wherein the pivot bracket is in the first position when the tailgate is in the closed position, and the pivot bracket is in the second position when the tailgate is in the open position.

10. A sensor assembly for installation into a component of a vehicle and movable between a plurality of positions relative to the vehicle, the assembly comprising:
a component biased based on gravitational orientation, the component operable in two component positions; and
a means of maintaining gravity bias in a preferred of the two component positions.

11. The sensor assembly of claim 10, further comprising a primary actuation mechanism that actuates the positioning of the component between a first position and a second position of the two component positions based on the positioning of a vehicle moveable member.

12. The sensor assembly of claim 11, wherein the means of maintaining gravity bias includes a biasing element operable to bias the primary actuation mechanism to a first position or a second position once the primary actuation mechanism rotates beyond a predetermined position.

13. The sensor assembly of claim 12, wherein the biasing element includes one of a torsion spring, an extension spring, a compression spring, and a leaf spring.

14. The sensor assembly of claim 11, wherein the vehicle moveable member is a tailgate supported for rotation by a vehicle body between a closed position and an open position.

15. The sensor assembly of claim 14, wherein the component is moved between the first position and the second position when the tailgate is moved between the closed position and the open position.
